(19) United States
(12) Patent Application Publication
(10) Pub. No.: US 2012/0019483 A1
(43) Pub. Date: Jan. 26, 2012

(54) OPTICAL TOUCH-CONTROLLED DISPLAY DEVICE AND ITS OPTICAL TOUCH-CONTROLLED MODULE

(76) Inventors: Cheng-Sheng Chiang, Taipei County (TW); Po-Fu Kuo, Taipei City (TW); Tsao-Yuan Fu, Taoyuan County (TW); Hui-Ju Hsu, Taichung County (TW)

(21) Appl. No.: 12/913,076

(22) Filed: Oct. 27, 2010

(30) Foreign Application Priority Data
Jul. 20, 2010 (TW) 099213830

(51) Int. Cl. G06F 3/042

(52) U.S. Cl. 345/175

(57) ABSTRACT

An optical touch-controlled module including a frame, a plurality of optical transceivers, and three reflective sticks is provided. The frame can be combined with a display module and includes a plurality of bars. The bars are connected with each other and surround a frame opening. The optical transceivers are disposed on the frame and located separately on the two opposite ends of one of the bars. Each of the reflective strips is disposed on one of the bars, and one of the reflective strips is located between the other two reflective strips. The reflective strips surround the frame opening and reflect the light emitted from each of the optical transceivers. Moreover, an optical touch-controlled display device including the optical touch-controlled module is also provided.

### CROSS-REFERENCE TO RELATED APPLICATION

This application claims the benefit of Taiwan Patent Application No. 099213830, filed on Jul. 20, 2010, which is hereby incorporated by reference for all purposes as if fully set forth herein.

### BACKGROUND OF THE INVENTION

1. Field of Invention

The present invention relates to a touch display device, and more particularly to an optical touch-controlled display device and its optical touch-controlled module.

2. Related Art

In the current level of touch-controlled technology, the optical touch-controlled display device has been developed, and the optical touch-controlled display device uses the receiving and blocking of light to detect the position of a finger, a pen, or the other object on the screen. Thus, the users can operate the optical touch-controlled display devices to control mobile phones, personal computers, personal digital assistants, also known as PDAs, or any other electronic devices with display screens.

### SUMMARY OF THE INVENTION

Accordingly, the present invention is directed to an optical touch-controlled display device able to detect the position of the object on the surface of display screen.

The present invention is directed to an optical touch-controlled module applicable to the optical touch-controlled display device.

The present invention provides an optical touch-controlled module comprising a frame, two optical transceivers, and three reflective sticks. The frame can be combined with a display module and comprises a plurality of bars. The bars are connected with each other and surround a frame opening. The optical transceivers are disposed on the frame and located separately in the two opposite ends of one of the bars. Each of the reflective strips is disposed on one of the bars, and one of the reflective strips is located between the other two reflective strips. The reflective strips surround the frame opening and reflect the light emitted from each of the optical transceivers.

The present invention also provides an optical touch-controlled display device comprising a display module and the optical touch-controlled module. The optical touch-controlled module is combined with the display module. The frame is disposed on the display module.

In the view of the above, since the reflective strips reflect light emission from each of the optical transceivers, the optical transceivers not only emit light, but also receive light reflected by the reflective strips. Thus, the optical transceivers can detect the position of the object (such as a finger, a pen) on the display screen through receiving light, so that a user operates the optical touch-controlled display device in the present invention to control an electronic device with a display screen.

In order to make the aforementioned features of the present invention more comprehensible, embodiments accompanied with figures are described in detail below.

### BRIEF DESCRIPTION OF THE DRAWINGS

FIG. 1A is a three-dimensional schematic view of an optical touch-controlled display device according to the embodiment of the present invention.

FIG. 1B is an exploded schematic view of the optical touch-controlled display device in FIG. 1A.

FIG. 2 is a cross-sectional schematic view of FIG. 1A along line I-I.

FIG. 3 is a cross-sectional schematic view of FIG. 1A along line II-II.

### DETAILED DESCRIPTION OF THE INVENTION

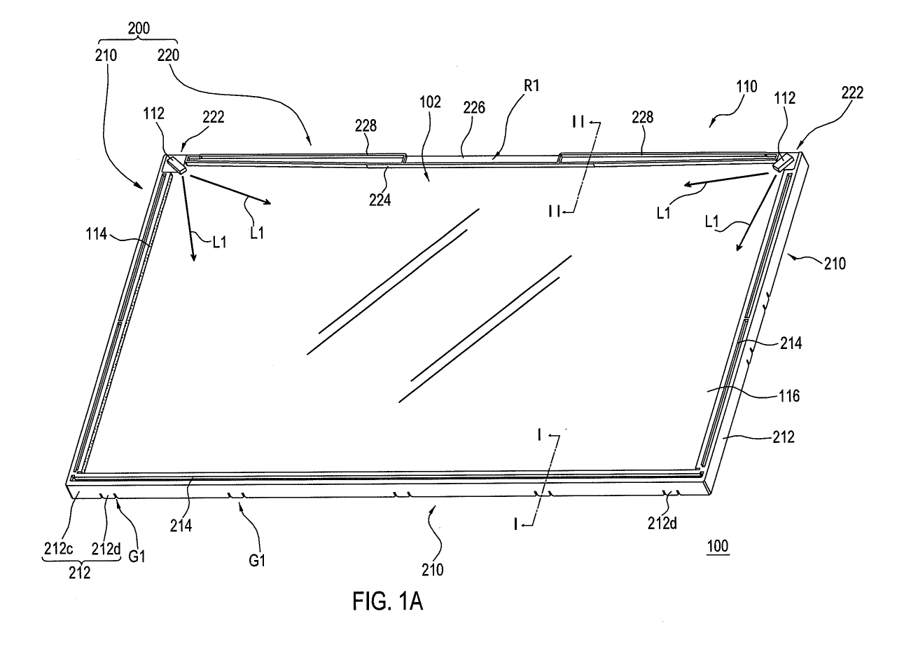

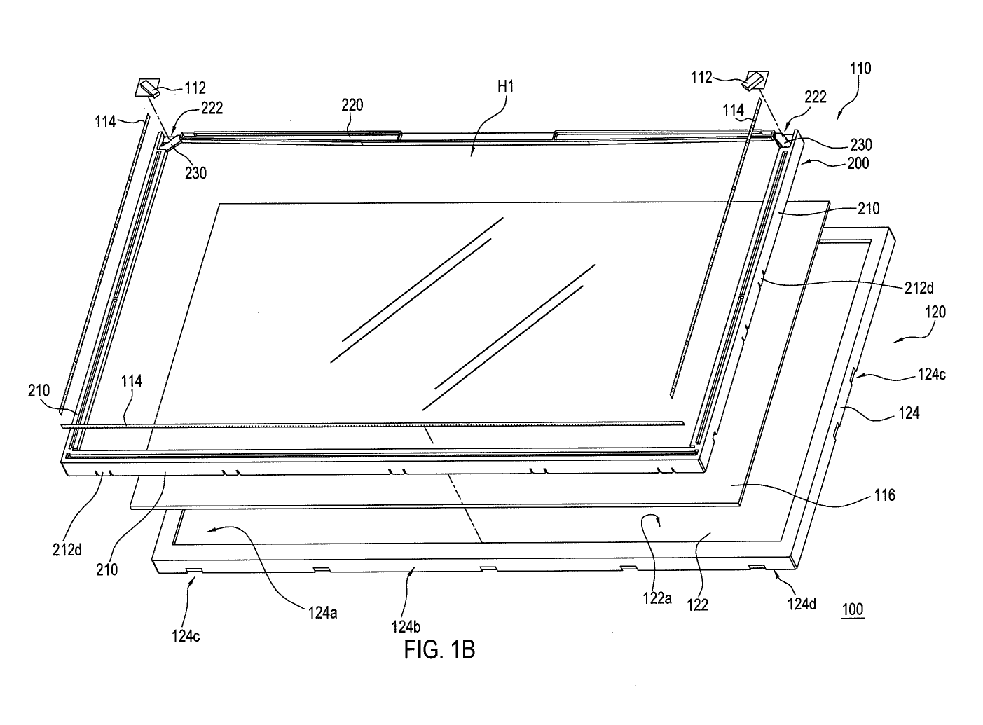

FIG. 1A is a three-dimensional schematic view of an optical touch-controlled display device according to the embodiment of the present invention, and FIG. 1B is an exploded schematic view of the optical touch-controlled display device in FIG. 1A. Referring to FIGS. 1A and 1B, the optical touch-controlled display device 100 includes an optical touch-controlled module 110 and a display module 120. The optical touch-controlled module 110 can be combined with the display module 120. For example, the optical touch-controlled module 110 can be fastened, locked, or stuck to the display module 120 in order to combine with display module 120. After the optical touch-controlled module 110 is combined with the display module 120, the optical touch-controlled module 110 is disposed on the display module 120.

The optical touch-controlled module 110 includes a frame 200, two optical transceivers 112, and three reflective strips 114. The frame 200 includes a plurality of bars 210 and 220. The bars 210 and 220 are connected with each other. In detail, the bar 220 is located between two of the bars 210, and the bar 220 and 210 enclose the frame opening H1. Taking FIG. 1A and FIG. 1B for example, the number of the bars 210 is three, and the number of the bar 220 is only one. The bars 210 and 220 are formed the frame 200 by connecting with each other and enclose the frame opening H1, which is in rectangle shape. Furthermore, the frame 200 can be made of metal or plastic.

The optical transceivers 112 and the reflective strips 114 are disposed on the frame 200, and each of reflective strips 114 is disposed on a bar 210 or a bar 220. For example, the optical transceivers 112 can be fastened or stuck on the frame 200, and the reflective strips 114 can be separately stuck to the bars 210 and 220 with adhesive. Furthermore, one of the reflective strips 114 is located between the other two reflective strips 114, and the reflective strips 114 enclose the frame opening H1.

According to the above, the optical transceivers 112 are located on two opposite ends 222 respectively, so the optical transceivers 112 are located in relatively opposite positions. Moreover, the ends 222 can be separately connected to an end of one bar 210 and an end of the other bar 210, so that the optical transceivers 112 can be located on two corners of the frame 200 separately, as illustrated in FIG. 1A.

In this embodiment, the frame 200 may also include two supporting parts 230 (as illustrated in FIG. 1B.). Each supporting part 230 is connected to the neighboring bars 210 and 220, and the supporting parts 230 are located separately in the ends 222. The optical transceivers 112 individually are disposed on the supporting parts 230. When the optical transceiver 112 is locked on the frame 200, each supporting part 230 can have as least one screw hole (not illustrated), so the optical transceivers can be locked on the supporting part 230 with on or more than one screw.

The optical transceiver 112 can not only emit light L1, but also receive the light L1. The light L1 may be visible light or invisible light. When the light L1 is invisible light, the light L1 may be infrared light. The reflective strips 114 can reflect visible light or invisible light (such as infrared light), so that the reflective strips 114 can reflect light L1 emitted by each of the optical transceivers 112, thereby the light L1 emitted to the optical transceivers 112 and received by the optical transceivers 112.

When there is an object (not illustrated), for example, a finger or a pen, approaching or touching the screen area 102 of the optical touch-controlled display device 100, the object will block the partial path of light, thereby making a shadow (not illustrated) on the screen area 102. The optical transceivers 112 can detect the position where the shadow is located by receiving the light, so as to gain the object's position on the screen area 102.

Furthermore, the optical touch-controlled module 110 may further include a transparent plate 116. The transparent plate 116 is disposed in the frame 200 and sandwiched between frame 200 and display module 120. The bars 210 and the bar 220 will surround the transparent plate 116, so the transparent plate 116 is located in the frame opening H1. The material of the transparent plate 116 may be glass or plastic, for example, the transparent plate 116 may be a tempered glass plate or a plastic plate, and the plastic plate can be made of polymethylmethacrylate, PMMA, also known as acrylic. That is, the transparent plate 116 can be an acrylic plate.

Once the optical touch-controlled module 110 is combined with the display module 120, the transparent plate 116 will be placed upon the display module 120. When a finger, a pen or other object approaches or touches the screen area 102, the transparent plate 116 can protect the display module 120 beneath and prevent the display module 120 from being scratched by the objects (like the finger or the pen). Besides, the transparent plate 116 can be with a quite flat surface to serve as the touch-controlled area for the finger, the pen, or other object, so that the optical transceivers 112 can precisely detect the positions of the object on the screen area 102, so as to increase the accuracy of the optical touch-controlled display device 100.

The display module 120 includes of a display body 122 and an outer frame 124. The display body 122 has a display face 122a, and the display face 122a can display images. The outer frame 124 is combined with the display body 122 and surrounds the display body 122. The outer frame 124 has an opening 124a, and the opening 124a exposes the display face 122a, so that the viewers can watch the image displayed by display face 122a through opening 124a. Furthermore, the outer frame 124 can be made of metal.

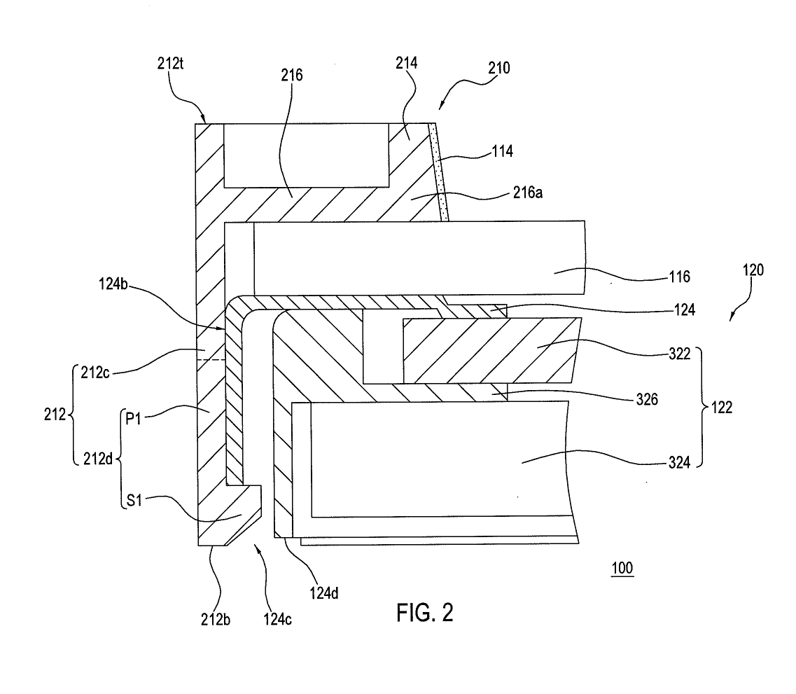

FIG. 2 is a cross-sectional schematic view of FIG. 1A along line I-I. Referred to FIG. 1A and FIG. 2, in this embodiment, the display module 120 may be a Liquid Crystal Module (LCM). In detail, the display body 122 includes a LCD panel 322, a backlight module 324 and an inner frame 326.

The LCD panel 322 is disposed above the backlight module 324, and the backlight module 324 can be a direct type backlight module or a side type backlight module. The inner frame 326 surrounds the LCD panel 322 and backlight module 324, and can be combined with the outer frame 124, so the LCD panel 322 is sandwich between the outer frame 124 and inner frame 326. Besides, the inner frame 326 can be made of plastic.

The optical touch-controlled module 110 and the display module 120 can be combined through means of implementation, like being fastened, locked, or stuck, and in the following example, the optical touch-controlled module 110 and the display module 120 are both fastened to be combined. However, the combination of the optical touch-controlled module 110 and the display module 120 through fastening is only one of means of implementation in the present invention, but not intended to limit the present invention.

In the frame 200 in this embodiment, each of the bars 210 can includes of an outer wall 212, an inner wall of 214 and a connection part 216, and in the same bar 210, the connection part 216 is connected with and between the outer wall 212 and inner wall 214. The reflective strips 114 are individually disposed to the inner walls 214, for example the reflective strips can be stuck to the inner walls 214.

In the frame 200 of this embodiment, each of bars 210 may include an outer wall 212, an inner wall 214 and a connection part 216. Within the same bar 210, the connection part 216 is connected between the outer wall 212 and the inner wall 214. The reflective strips 114 are separately disposed on the inner walls 214. For example, the reflective strips 114 may be stuck on the inner walls 214.

Each of outer walls 212 has a top 212t and a bottom 212b, and the top 212t is opposite to the bottom 212b. Within the same bar 210, the connection part 216 is located between top 212t and bottom 212b. Every connection part 216 has a connection end 216a, and each of the inner walls 214 are extended from the connection end 216a. Thus, the outer wall 212 sticks out from both of the opposite sides of the connection part 216, and the inner wall 214 only sticks out from one side of the connection part 216. Furthermore, the outer walls 212 can surround the inner walls 214 and the outer frame 124, and the inner walls 214 and the connection parts 216 can be disposed on the transparent plate 116.

Every outer wall 212 can include a plate 212c and a plurality of buckles 212d. The plate 212c is connected with the buckle 212d and the connection part 216, so the connection part 216 connects to the plate 212c and inner wall 214 and be located between the plate 212c and inner wall 214. The buckles 212d can include a connection plate P1 and a blocking part S1. The blocking part S1 is connected to the connection plate P1 and extents from connection plate P1 to the transparent plate 116 and the frame opening H1 (referred to FIG. 1B). Besides, there exists at least a gap G1 between each of the buckles 212d and the plate 212c connected to the buckle 212d, as shown in FIG. 1A.

Referring to FIG. 1B and FIG. 2, the buckles 212d can be fastened to the outer frame 124, so that the frame 200 may be combined with the outer frame 124. Moreover, the outer frame 124 may further have an outer side 124b and a plurality of gaps 124c. In addition, the gaps 124c are located in the outer side 124b and individually applicable to the buckles 212d. After the buckles 212d and the outer frame 124 are fastened, the blocking parts S1 are separately located within the gaps 124c. Thus, the optical touch-controlled module 110 can be fastened to the display module 120.

However, it is worth mentioning that the gaps 124c are not necessary to the outer frame 124. In detail, in other embodiments, when the optical touch-controlled module 110 is combined with the display module 120, the blocking parts S1 can block the bottom edge 124d outer frame 124. Thus, the optical touch-controlled module 110 can be fastened with the display module 120 even without any gaps 124c on the frame 124. Hence, it is just an example for the gaps 124c shown in FIG. 1B and FIG. 2, not intended to limit the present invention.

Besides, when there are no gaps 124c on the outer frame 124, the display module 120 can be equivalent to a conventional LCD module. That is, the optical touch-controlled module 110 can also be combined with the conventional LCD module. Therefore, when the display module is the conventional LCD module, the optical touch-controlled display device 100 can still be manufactured without any change in the current manufacturing process of the conventional LCD module.

In the embodiments shown in FIG. 1A, FIG. 1B and FIG. 2, a single outer wall 212 includes a plurality of buckles 212d, but in other embodiments, a single outer wall 212 includes only one buckle 212d, so that the quantity of buckles 212d illustrated in FIG. 1A, FIG. 1B, and FIG. 2 is just for an example, not intended to limit the present invention. Therefore, the bar 220 can also have only one buckle 212d or a plurality of buckles 212d, so that the bars 220 can be fastened to the outer frame 124 with buckles 212d.

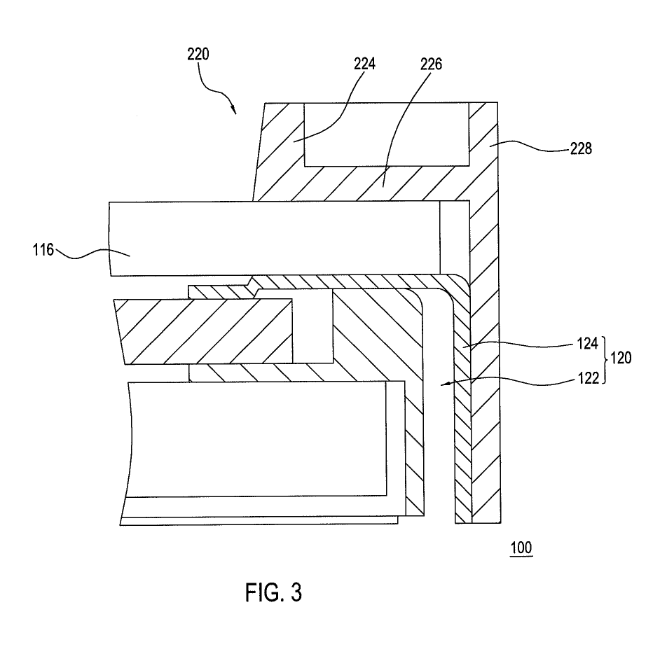

FIG. 3 is a cross-sectional schematic view of FIG. 1A along line II-II. Referring to FIG. 1A and FIG. 3, the bar 220 can include at least a masking strip 224 and a supporting base 226. The masking strip 224 is disposed on the supporting base 226, and located above the transparent plate 116 and between the optical transceivers 112. The masking strip 224 is located opposite to one of the reflective strips 114. When the optical transceivers 112 emit light L1, the masking strip 224 can block a part of the light L1, so as to reduce the light L1 emitted from the bar 220, thereby reducing the leaks of the light L1. Furthermore, the masking strip 224 and the supporting base 226 can be integrated to form one, or two independent components connected to each other.

Moreover, the bar 220 can include two protrusions 228. The protrusions 228 are located on the supporting base 226, and connected with the masking strip 224. There is a recess R1 between the protrusions 228. The recess R1 can provide space for an electronic part, and the electronic part is such as a web camera for a laptop. In other words, the electronic device (for example, a web camera) can be disposed in the optical touch-controlled module 110.

To sum up, the optical transceivers can not only emit light, but also receive light reflected by the reflective strips. Thus, when an object (for example, a finger, or a pen) approaches or touches the screen of the optical touch-controlled display device (like the screen area 102 shown in FIG. 1A) in the present invention, the optical transceivers can detect the position of the object on the screen through receiving of the light. Hence, users can operate the optical touch-controlled display device to control an electronic device with display screen, for example, a mobile phone, a computer, and a PDA, etc.

Besides, the optical touch-controlled module can have at least one buckle, and with the buckle, the optical touch-controlled module can be fastened to the display module. After the optical touch-controlled module and the display module are combined, when an extraordinary situation happens, for example, failure to align the optical touch-controlled module to the display module properly, or existence of dust, ashes, or particles between the optical touch-controlled module and the display module, the buckles can be loosed to take the optical touch-controlled module and the display module apart, so that the optical touch-controlled module and the display module can be reworked. Thus, the scrap rate of the optical touch-controlled display device can be reduced and increase the yield.

Furthermore, within the optical touch-controlled display device of the present invention, the display module can be equivalent to the conventional LCD module, that is, the optical touch-controlled module of the present invention can be combined with conventional LCD module. Thus, the present invention can manufacture the optical touch-controlled display devices without any change to the current manufacturing process of the conventional LCD module. In other words, the process of manufacturing the optical touch-controlled display devices will not impact the current manufacturing process of the LCD modules.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical touch-controlled module, comprising:
a frame, combined with a display module, wherein the frame including a plurality of bars, the bars are connected with each other and surround a frame opening;
two optical transceivers, disposed on the frame and located separately on two opposite ends of one of the bars; and
three reflective strips, wherein each of the reflective strips is disposed on one of the bars, and one of the reflective strips is located between the other two reflective strips, and the reflective strips surround the frame opening to reflect a light emitted from each of the optical transceivers.

2. The optical touch-controlled module according to claim 1, wherein the bar comprise:
an outer wall;
an inner wall; and
a connection part, connected between the outer wall and the inner wall, wherein the outer wall surrounds the inner wall, and the reflective strips disposed on the inner wall.

3. The optical touch-controlled module according to claim 2, wherein each of the outer walls has a top and a bottom opposite to the top, and the connection part is located between the top and the bottom, and each of the connection parts has a connection end from which each of the inner walls extends.

4. The optical touch-controlled module according to claim 2, wherein each of the outer walls comprise a plate and at least a buckle, the plate is connected to the buckle and the connection part, and the buckle comprises a connection plate and a blocking part connected to the connection plate, and extends from the connection plate toward the frame opening.

5. The optical touch-controlled module according to claim 4, wherein at least a gap exists between each of the buckles and the plate connected to the buckle.

6. The optical touch-controlled module according to claim 1, further comprising a transparent plate disposed in the frame, wherein the bars surround the transparent plate.

7. The optical touch-controlled module according to claim 1, wherein one of the bars comprise at least a masking strip and a supporting base, the masking strip is disposed on the supporting base and located between the optical transceivers.

8. The optical touch-controlled module according to claim 7, wherein the bar further comprises two protrusions disposed on the supporting base and connected to the masking strip, and a recess exists between the protrusions.

9. The optical touch-controlled module according to claim 1, wherein the frame further comprises two supporting parts, each of the supporting parts is connected to the neighboring bars, and the optical transceivers disposed on the supporting parts respectively.

10. The optical touch-controlled module according to claim 1, wherein the frame is made of plastic.

11. An optical touch-controlled display device, comprising:
a display module;
an optical touch-controlled module combined with the display module and comprising:
a frame, disposed on the display module and comprising a plurality of bars, wherein the bars are connected with each other and surrounds a frame opening;
two optical transceivers, disposed on the frame and located on two opposite ends of one of the bars; and
three reflective strips, wherein each of the reflective strips is disposed on one of the bars, and one of the reflective strips is located between the other two reflective strips, and the reflective strips surround the frame opening to reflect a light emitted from each of the optical transceivers.

12. The optical touch-controlled display device according to claim 11, wherein the display module comprise:
a display body, having a display face; and
an outer frame, surrounding the display body and having an opening, wherein the opening exposes the display face, and the outer frame is combined with the frame.

13. The optical touch-controlled display device according to claim 12, wherein the bar comprise:
an outer wall;
an inner wall; and
a connection part, connected between the outer wall and the inner wall, wherein the outer wall surrounds the inner wall, and the reflective strip disposed on the inner wall.

14. The optical touch-controlled display device according to claim 13, wherein the outer wall has a top and a bottom opposite to the top, and the connection part is located between the top and the bottom, and each of the connection parts has a connection end from which each of the inner walls extends.

15. The optical touch-controlled display device according to claim 13, wherein each of the outer walls comprise a plate and at least a buckle, the plate is connected to the buckle and the connection part, and the buckle comprises a connection plate and a blocking part connected to the connection plate, and extends from the connection plate toward the frame opening.

16. The optical touch-controlled display device according to claim 15, wherein at least a gap exists between each of the buckles and the plate connected to the buckle.

17. The optical touch-controlled display device according to claim 15, wherein the outer frame has an outer side and at least a gap located in the outer side, and the blocking part is located in the gap.

18. The optical touch-controlled display device according to claim 11, wherein the optical touch-controlled module further comprises a transparent plate disposed in the frame, and the bars surround the transparent plate.

19. The optical touch-controlled display device according to claim 11, wherein one of the bars comprises at least a masking strip and a supporting base, the masking strip is disposed to the supporting base and located between the optical transceivers.

20. The optical touch-controlled display device according to claim 19, wherein the bar comprises two protrusions disposed on the supporting base and connected to the masking strip, and a recess exists between the protrusions.

21. The optical touch-controlled display device according to claim 11, wherein the frame further comprises two supporting parts, each of the supporting parts is connected to the neighboring bars, and the optical transceivers disposed on the supporting parts respectively.

22. The optical touch-controlled display device according to claim 11, wherein the frame is made of plastic.
